(19) United States
(12) Patent Application Publication
(10) Pub. No.: US 2020/0132289 A1
(43) Pub. Date: Apr. 30, 2020

(54) INDUCTIVE ILLUMINATION STRUCTURE OF LIGHTING DEVICE

(71) Applicant: CHIN-MU HSIEH, TAINAN CITY (TW)

(72) Inventor: CHIN-MU HSIEH, TAINAN CITY (TW)

(21) Appl. No.: 16/176,143

(22) Filed: Oct. 31, 2018

(51) Int. Cl. F21V 23/04; F21V 1/00; F21S 8/00

(52) U.S. Cl. CPC F21V 23/0442; F21S 8/033; F21V 1/00

(57) ABSTRACT

An inductive illumination structure of a lighting device is disclosed. The lighting device includes a main body having a lower accommodating chamber and an upper accommodating chamber and a mounting base vertically connected to the main body. The inductive illumination structure includes a moving object sensing unit, a lighting unit, and a signal processing unit. The moving object sensing unit is disposed inside the lower accommodating chamber of the main body, and includes a compartment seat having sector spaces and sensors disposed inside the sector spaces, respectively. The lighting unit is disposed inside the upper accommodating chamber of the main body, and includes a multi-segment folding plate and light sources disposed on an outer wall of the multi-segment folding plate. The signal processing unit is disposed inside the mounting base, and is electrically connected to the sensors and the light sources, respectively.

### FIELD OF THE INVENTION

The present invention relates to an inductive illumination structure of a lighting device, and more particularly to an inductive illumination structure having a plurality of light sources and a plurality of sensors that correspond to each other in position and in number. When one of the sensors detects the presence of a moving object, the signal processing unit can activate the light source corresponding to the sensor to provide illumination required for the moving object.

### BACKGROUND OF THE INVENTION

FIG. 1 is a planar view of a security light disclosed in the U.S. Pat. No. 8,461,991. The security light 1 includes a mounting base 11 positioned to a longitudinal plane 2, a support seat 12 having a plurality of moving object sensors 121 arranged in a fan shape, a motor 13 having a rotating shaft 131 mounted on top of the support seat 12, and a lamp holder 14 coupled to the rotating shaft 131. The moving object sensors 121 of the security light 1 are electrically connected the motor 13. The support seat 12 is parallel to the longitudinal plane 2 and vertically connected to the mounting base 11. The rotating shaft 131 is driven by the motor 13 to pivot clockwise or counterclockwise, so that the lamp holder 14 is pivoted to the relative position of the moving object sensor 121 that emits the sensing signal. The lamp holder 14 includes at least one light source therein. When the first moving object sensor 121 of the security light 1 senses that a moving object (human or animal) enters the sensing range, it will output a signal to start the motor 13. The rotating shaft 131 is pivoted to turn the lamp holder 14 to the relative position of the moving object sensor 121 that emits the sensing signal, and the internal light source of the lamp holder 14 is illuminated to achieve the purpose of illuminating the moving object. When the moving object continues to move into the sensing range to which the second moving object sensor 121 belongs, the second moving object sensor 121 outputs a signal to start the motor 13 and to pivot the rotating shaft 131. The rotating shaft 131 turns the lamp shade 14 to the relative position of the moving object sensor 121 that emits the sensing signal.

According to the above description, when in use, the disclosed security light has the following shortcomings:

1. The motor disclosed in the above patent increases the manufacturing cost of the security light. The motor often activates the lamp holder to turn, which results in high maintenance cost.

2. The motor disclosed in the above patent bears the weight of the lamp holder through the rotating shaft, which shortens the service life of the security light.

The above shortcomings clearly show the problems in the implementation of the above patent. Accordingly, the inventor of the present invention has devoted himself based on his many years of practical experiences to solve these problems of high manufacturing cost, high maintenance cost and short service life of the security light.

### SUMMARY OF THE INVENTION

The primary object of the present invention is to provide an inductive illumination structure of a lighting device that can accurately provide illumination required for a moving object. The failure rate is reduced greatly. The light sources start the automated inductive illumination structure of the lighting device. The light sources of the lighting unit correspond in position and in number to the sensors of the moving object sensing unit. When one of the sensors of the inductive illumination structure detects the presence of the moving object, the signal processing unit can activate the light source corresponding to the sensor to provide illumination required for the moving object.

The present invention provides an inductive illumination structure of a lighting device. The lighting device comprises a main body having a lower accommodating chamber and an upper accommodating chamber and a mounting base vertically connected to the main body. The mounting base is fixedly coupled to a longitudinal plane. The inductive illumination structure includes a moving object sensing unit, a lighting unit, and a signal processing unit. The moving object sensing unit is disposed inside the lower accommodating chamber of the main body. The moving object sensing unit includes a compartment seat having a plurality of sector spaces and a plurality of sensors disposed inside the sector spaces, respectively. The lighting unit is disposed inside the upper accommodating chamber of the main body. The lighting unit includes a multi-segment folding plate and a plurality of light sources disposed on an outer wall of the multi-segment folding plate. The signal processing unit is disposed inside a horizontal section of the mounting base of the lighting device. The signal processing unit is electrically connected to the sensors and the light sources, respectively.

Preferably, a front edge of the lower accommodating chamber is provided with a transparent cover.

Preferably, a front edge of the upper accommodating chamber is provided with a lampshade.

Preferably, the compartment seat has a semi-circular shape, and the compartment seat is equally divided into the sector spaces each gradually enlarged outwardly.

Preferably, the sector spaces each have an included angle of 45 or 60 or 90 degrees.

Preferably, the light sources correspond in position and in number to the sensors.

In the inductive illumination structure of the lighting device provided by the present invention, the light sources of the lighting unit are set corresponding in position and in number to the sensors of the moving object sensing unit. When the first sensor of the inductive illumination structure detects the presence of the moving object, the first light source corresponding to the first sensor is activated by the signal processing unit to provide illumination for the moving object. When the moving object continues to move, the second sensor detects the presence of the moving object, and the second light source corresponding to the second sensor can be activated by the signal processing unit to sequentially provide illumination for the moving object. The inductive illumination structure of the lighting device of the present invention can accurately provide illumination required for the moving object. The failure rate is reduced greatly. The light sources start the automated inductive illumination structure of the lighting device.

### BRIEF DESCRIPTION OF THE DRAWINGS

FIG. 1 is a schematic view of a conventional security light fixed to a longitudinal plane;

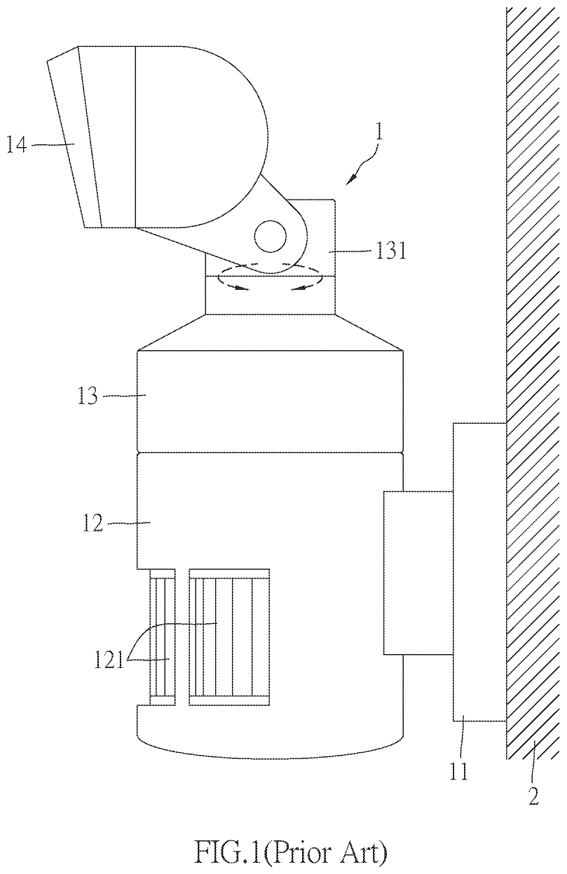

FIG. 2 is a top perspective view of the inductive illumination structure of the lighting device of the present invention;

FIG. 3 is a bottom perspective view of the inductive illumination structure of the lighting device of the present invention;

FIG. 4 is a schematic view of the inductive illumination structure of the lighting device of the present invention fixed to the longitudinal plane;

FIG. 5 is a cross-sectional view taken along line A-A of FIG. 4; and

FIG. 6 is a cross-sectional view taken along line B-B of FIG. 4.

### DETAILED DESCRIPTION OF THE PREFERRED EMBODIMENTS

With regard to the technical means by which the present invention achieves the above-mentioned objects, embodiments of the present invention will now be described, by way of example only, with reference to the accompanying drawings.

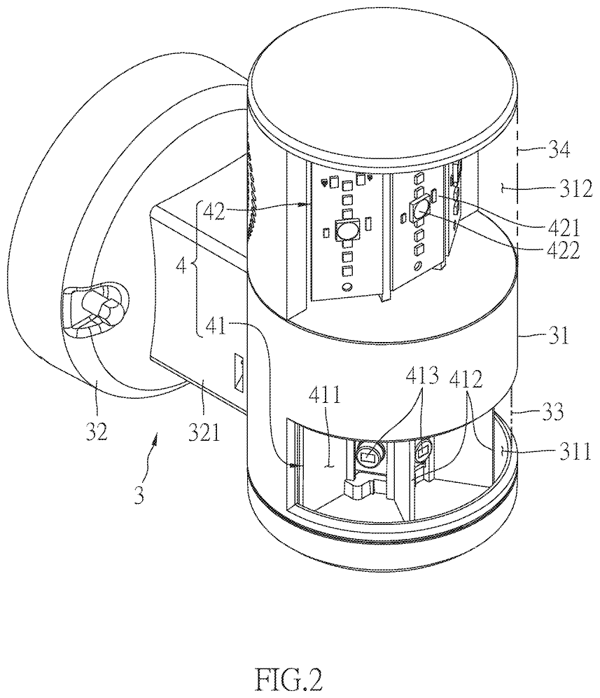

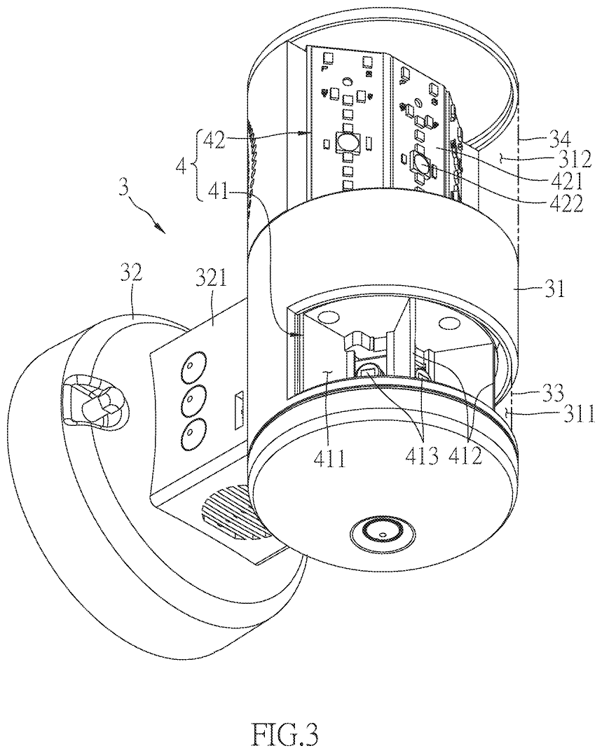

Referring to FIGS. 2 to 4, the present invention provides an inductive illumination structure 4 of a lighting device 3. The lighting device 3 comprises a main body 31 having a lower accommodating chamber 311 and an upper accommodating chamber 312 and a mounting base 32 vertically connected to the main body 31. The mounting base 32 is fixedly coupled to a longitudinal plane 5.

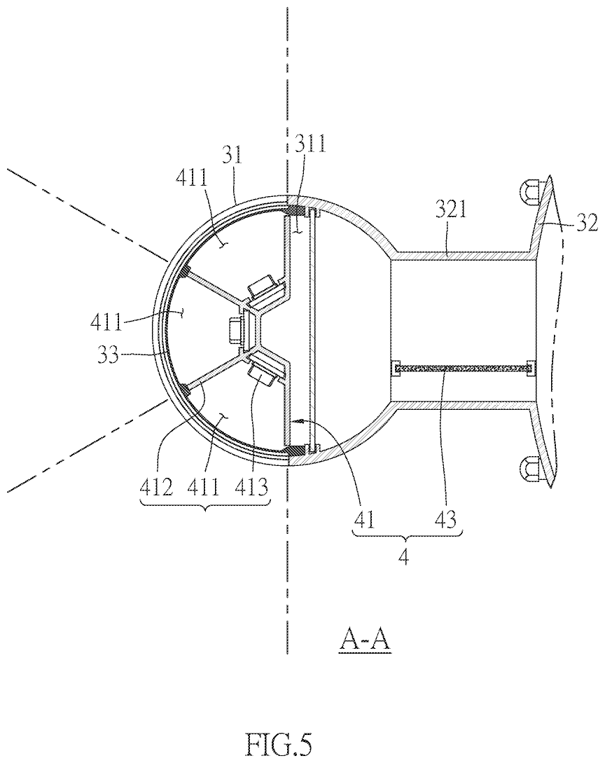

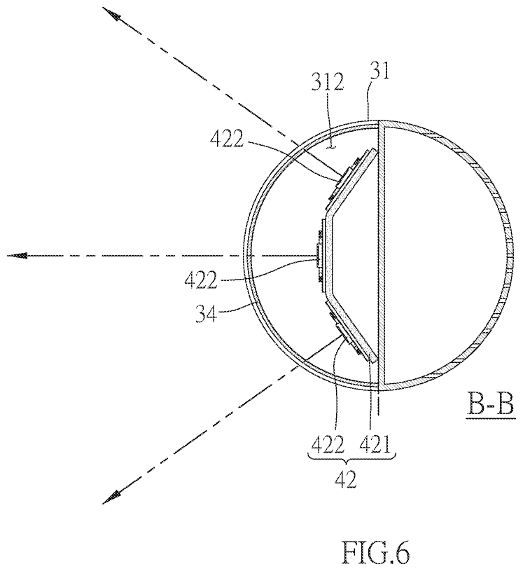

Referring to FIGS. 5 and 6, the inductive illumination structure 4 includes a moving object sensing unit 41, a lighting unit 42, and a signal processing unit 43. The moving object sensing unit 41 is disposed inside the lower accommodating chamber 311 of the main body 31. The moving object sensing unit 41 includes a compartment seat 412 having a plurality of sector spaces 411 and a plurality of sensors 413 disposed inside the sector spaces 411, respectively. The lighting unit 42 is disposed inside the upper accommodating chamber 312 of the main body 31. The lighting unit 42 includes a multi-segment folding plate 421 and a plurality of light sources 422 disposed on the outer wall of the multi-segment folding plate 421. The signal processing unit 43 is disposed inside a horizontal section 321 of the mounting base 32 of the lighting device 3. The signal processing unit 43 is electrically connected to the sensors 413 and the light sources 422, respectively.

Referring to FIGS. 2 to 4, a front edge of the lower accommodating chamber 311 is provided with a transparent cover 33. A front edge of the upper accommodating chamber 312 is provided with a lampshade 34. The compartment seat 412 has a semi-circular shape. The compartment seat 412 is equally divided into the sector spaces 411 each gradually enlarged outwardly. The included angle of the sector space 411 may be set to any parameter, such as 45 or 60 or 90 degrees. The light sources 422 correspond in position and in number to the sensors 413.

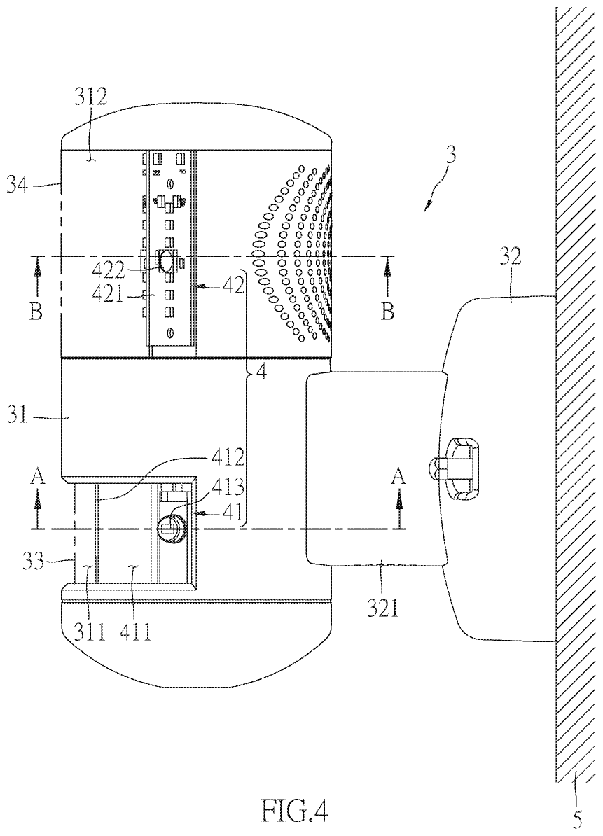

Referring to FIGS. 4 and 5, the inductive illumination structure 4 of the lighting device 3 provided by the present invention is implemented. The light sources 422 of the lighting unit 42 correspond in position and in number to the sensors 413 of the moving object sensing unit 41. When the first sensor 413 of the inductive illumination structure 4 detects the presence of the moving object (the moving object is in the sensing range of the first sensor 413), the first light source 422 corresponding to the first sensor 413 is activated by the signal processing unit 43 electrically connected to the first sensor 413 and the light source 422. The first light source 422 provides illumination for the moving object. When the moving object continues to move and the second or third sensor 413 detects the presence of the moving object, the second or third light source 422 corresponding to the second or third sensor 413 can be activated by the signal processing unit 43. The second or third light source 422 sequentially provides illumination for the moving object.

Referring to FIGS. 5 and 6, the inductive illumination structure 4 of the lighting device 3 of the present invention can accurately provide illumination required for the moving object. The plurality of light sources 422 and the same number of sensors 413 are disposed in the upper accommodating chamber 312 and the lower accommodating chamber 311 of the main body 312, respectively. When a moving object is detected in the sensing range of one of the sensors 413, the signal processing unit 43 receives the sensing signal, and then transmits an activation signal to the light source 422 located above the sensor 413 to accurately provide illumination required for the moving object.

Referring to FIGS. 5 and 6, the light source 422 of the inductive illumination structure 4 of the present invention is activated automatically and can be changed in response to the change of the position of the moving object. When the moving object is detected in the sensing range of the first sensor 413, the first light source 422 corresponding to the first sensor 413 can be activated by the signal processing unit 43. When the moving object continues to move (the first sensor 413 does not detect the presence of the moving object, the first light source 422 is turned off), the moving object is detected by the second sensor 413, and the second light source 422 corresponding to the second sensor 413 can be activated by the signal processing unit 43. The startup and shutdown of each light source 422 is fully automated.

Through the description of the above embodiments, it can be seen that the inductive illuminating structure of the lighting device of the present invention has the following effects:

1. The present invention can provide the required illumination for moving objects quickly and accurately. It saves the cost of the motor provided in the conventional lighting device and simplifies the components of the lighting device. The inductive illumination structure of the lighting device is innovative and can reduce the manufacturing cost.

2. In the present invention, the light sources 422 are located above the corresponding sensors 413, respectively. The light sources 422 and the sensors 413 are disposed inside the main body 312. Each light source 422 receives the signal of the corresponding sensor 413. There is no need for all the light sources to pivot and swing along with the moving object, so that the failure rate of the inductive illumination structure of the lighting device is reduced greatly.

3. The light sources 422 of the present invention correspond in position and in number to the sensors 413. The activation of the light source 422 is automated by the signal processing unit 43 and changes in response to changes in the location of the moving object. When the moving object moves from the first sensing area to the second sensing area, the first sensor 413 turns off the first light source 422 because no moving object is detected. The second sensor 413 activates the corresponding second light source 422 when detecting the presence of the moving object. The light sources start the automated inductive illumination structure of the lighting device.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An inductive illumination structure of a lighting device, the lighting device comprising a main body having a lower accommodating chamber and an upper accommodating chamber and a mounting base vertically connected to the main body, the mounting base being fixedly coupled to a longitudinal plane; characterized by:
the inductive illumination structure including a moving object sensing unit, a lighting unit, and a signal processing unit; the moving object sensing unit being disposed inside the lower accommodating chamber of the main body, the moving object sensing unit including a compartment seat having a plurality of sector spaces and a plurality of sensors disposed inside the sector spaces respectively; the lighting unit being disposed inside the upper accommodating chamber of the main body, the lighting unit including a multi-segment folding plate and a plurality of light sources disposed on an outer wall of the multi-segment folding plate; the signal processing unit being disposed inside a horizontal section of the mounting base of the lighting device, the signal processing unit being electrically connected to the sensors and the light sources, respectively.

2. The inductive illumination structure of the lighting device as claimed in claim 1, wherein a front edge of the lower accommodating chamber is provided with a transparent cover.

3. The inductive illumination structure of the lighting device as claimed in claim 1, wherein a front edge of the upper accommodating chamber is provided with a lampshade.

4. The inductive illumination structure of the lighting device as claimed in claim 1, wherein the compartment seat has a semi-circular shape, and the compartment seat is equally divided into the sector spaces each gradually enlarged outwardly.

5. The inductive illumination structure of the lighting device as claimed in claim 1, wherein the sector spaces each have an included angle of 45 or 60 or 90 degrees.

6. The inductive illumination structure of the lighting device as claimed in claim 1, wherein the light sources correspond in position and in number to the sensors.
